(19) United States
(12) Patent Application Publication
(10) Pub. No.: US 2005/0075170 A1
(43) Pub. Date: Apr. 7, 2005

(54) Method and electronic device for control of interactive game

(76) Inventors: Jorge Juan Garcia Alonso, Madrid (ES); Silvia Garcia Alonso, Madrid (ES)

Correspondence Address: SCHIFF HARDIN, LLP;PATENT DEPARTMENT, 6600 SEARS TOWER, CHICAGO, IL, 60606-6473, US

(21) Appl. No.: 10/647,941

(22) Filed: Aug. 26, 2003

(30) Foreign Application Priority Data
Feb. 27, 2003 (ES) P200300477

(51) Int. Cl. A63F 13/00

(52) U.S. Cl. 463/42

(57) ABSTRACT

Electronic device for control of an interactive game in which the user advances by means of overcoming sensory tests (sight, touch, smell and ingenuity) and tests of skill. The control device is organized based on a data network, with a server element (6), a switch element (7), several cell control computers (sub-network) (1-5) and other enigma control computers (sensory tests) (1′-51′). The user actions, through an electronic console (12, 13) which identifies him, are detected by the control elements governed by microprocessor, which communicate them to the central device in order to interact again with the user by means of sound messages over the background sound system of the game or through the headphone that each user console incorporates.

### OBJECT OF THE INVENTION

The present invention is centred on a method and an electronic device for control of an interactive game. The concept is based on a video game but with a physical component similar to an attraction. The concept has several levels, in which each user can win points by overcoming sensory tests (enigmas) and tests of skill (challenges). In each level the user is in communication with the control device which at all times directs the performance of the game. The control device establishes the game logic: the players, matches and scores, control of turns, points, lives, clues, rules of the game, operation of the tests, opening of doors and messages to the player.

### BACKGROUND OF THE INVENTION

As background of the network that controls the interactive game is to be found the patent ES2078152 (“Integrated system of control and data transmission for the administration of multiple peripheral subsystems”) which discloses a dual ring data network, formed by a plurality of nodes interconnected by pairs of main channels and which includes peripheral subsystems connected to each node by means of secondary channels.

Patent documents are likewise known wherein games are disclosed which carry out sensory tests, such as the patent U.S. Pat. No. 5,918,882 which discloses a series of tests relative to the five senses and includes the sixth sense (extrasensory perception). This game consists of a board on which the sense is indicated about which a question will be asked by means of a card (there is a pile of cards for each sense). On answering the questions correctly, the player advances on the board as a function of the difficulty of the question.

In the state of the art there are also games which include elements referring exclusively to a single sense. The patents U.S. Pat. No. 6,149,873 (“Computer game enhancement”), U.S. Pat. No. 4,487,585 (“Educational toy having fragrance association means”) and U.S. Pat. No. 4,687,203 (“Scratch and smell game”) concern olfaction, the sense of smell. The patent U.S. Pat. No. 6,149,873 consists of an odour-diffusing electromechanical element which serves as a complement for a computer game. The patent U.S. Pat. No. 4,487,585 discloses an educational game for children which allows elements or forms to be associated with their associated fragrance. The odour is spread when a surface is scratched associated with a piece, which on being extracted from its hole, leaves the fragrant surface exposed to the air. The patent U.S. Pat. No. 4,687,203 is a similar game to the previous one wherein under pieces of the same size with drawings of fruits is to be found a fragrant element associated with each fruit. Each piece should be placed in the receptacle with its corresponding smell.

The patents U.S. Pat. No. 1,877,643 (“Device for testing sensory and mental faculties”) and U.S. Pat. No. 4,840,374 (“Game utilizing the sense of touch”) disclose games in relation with the tactile sense. The patent U.S. Pat. No. 1,877,643 consists of a set of spheres of different diameter and on a tray with holes of different sizes into which, with the eyes blindfolded, the spheres should be inserted arranged on a basis of the size thereof and the size of the holes. The patent U.S. Pat. No. 4,840,374 is a game to develop the tactile sense which consists of a hollow cylindrical recipient, open at both ends, in the centre of which is a surface with holes of various shapes, through which the player has to pass figures having the shape corresponding to the hole.

Challenges are tests of skill and physical ability. One of the tests consists of a room full of balls of different sizes. There is a patent which resembles this challenge, since it also consists of different games with foam balls: WO9706867 (“Interactive play structure”). Specifically it consists of a game space communicated by tunnels, network bridges and ladders. One of the elements is a pool filled with foam balls where the children play and move about in the artificial medium created by the balls. Another element of the game space consists of an actuator which the children work and which puts the foam balls in movement, accelerates them and transports them from one place to another.

### DESCRIPTION OF THE INVENTION

The present leisure concept consists of an interactive activity which combines intelligence and physical ability with strong sensory impacts. The concept is based on the graphic adventure video games. In the video games existing up to now the player is limited to acting on the control system by means of an electromechanical element (keyboard or joystick) which creates for him the impression of participating in an adventure in which he really does not form part. Even in virtual reality video games the player does not cease to be a bystander that remains stationary before what is being perceived visually. The present invention overcomes that limitation since the player is the main character participating in the adventure within a field of play, and depending upon his skill and ability will be able to advance in the game. The game also resembles role, labyrinth and amusement park games. The players enter an artificial environment similar to a labyrinth, wherein special film effects are encountered. It is the player who moves physically inside the game and who with his skill has to overcome tests that challenge him both intellectually and physically. In each match his sensory abilities are put to the test, having to respond correctly to questions in connection with his perceptions. The main character is the user himself, who will advance in the match by moving physically through various stations, confronting sensory tests, tests of ingenuity and tests of skill and ability.

The game is structured in levels in which tests are included that have to be overcome and which grow progressively in difficulty. Points are achieved by overcoming tests of skill (challenges), like crossing a room full of balls of different sizes and finding therein an item on a wall or on the floor which wins him points; by means of tests of sensory ability (correctly identifying a smell blown over the user from among four possible answers, correctly identifying an object touched with the fingers without seeing it from among four possible answers, or correctly responding to a question from among four possible answers on some images displayed previously on a screen); or by tests of intelligence by means of an ingenious question, for which he will have to choose one answer from among four possible.

On each screen the challenges will score as a function of their difficulty, and the enigmas as a function of the established range of difficulty (the simplest sight, then smell, then touch and, lastly, the most complex ingenuity). It is also possible to win extraordinary points which will be distributed randomly among the players. It is also possible to win a life giving the right to play another match at another time.

The course of the user through the various tests is directed by the electronic control device. Before beginning to play the user is provided with an electronic console which identifies him and which locates him at all times within the game. Depending on his ability and ingenuity he will be guided toward some tests or others by the electronic control device, by means of messages in the background sound or through the earphone of his console. The game includes a number of clues which the player will receive through messages in his earphone, by means of symbols over the course of the game or by means of other graphic, written or audible clues. The goal of the user is to leave the multi-activity enclosure alive winning the greatest possible number of points.

The electronic control device directs the user's interaction with the sensory tests, with the tests of skill and with the means of channelling the system (opening of doors or messages in corridors). The sealed rooms will act as traffic lights or as controllers of user traffic.

Each level of the game is governed by a communication cell comprising a computer (cell PC) and a cell control element. These cell control computers are connected to a cluster of servers, all of which form a dual ring network, through some switches. Each higher level or cell introduces greater difficulty for the user.

The sensory tests (enigmas) are directed by a computer for each test. These computers are connected to the dual ring and to the switches by means of RJ45 cable. Each enigma also has a control element which communicates with the cell control elements to establish the interaction with the persons that are in the system. The enigmas consist of a screen on which a question is formulated in relation with a sense (sight, touch and smell) or a question of ingenuity. In addition they also have an industrial button for each of the possible answers that are displayed on screen, and for which the user has a limited time to respond.

The tests of skill consist of activities in which the user has to demonstrate physical ability and astuteness to overcome them, like for example finding an item on a wall in a room filled with balls (like a pool). In this way he obtains a higher score and can advance in the challenge as a whole reaching new tests which allow him to increase his score even more.

The regulation of the mechanical elements and the communication with user terminals (electronic storage devices, ESD) is carried out through the control elements, which are devices formed by a basic module (microprocessor, a data storage memory, a connector for connection to the network, a power supply, an RF transmitter/receiver with a range of 5 to 10 metres), and, optionally a device actuation relay (for doors) and/or an RF/ID reader. The control elements are mounted on each door and in each room or passing place. Also in each cell and in each enigma one or two control elements will be coupled to the control computer of that cell or enigma.

The electronic storage devices (ESD) or consoles have the mission of communicating the user with the rest of the mechanisms. These devices have the following main functions: storing the unique ESD identifier (therefore they position the player carrying that ESD), storage of language, of time available, of lives, points, enigmas and doors; sending/reading data (signals to the central device, signals to control elements—relays or network points—and activation of enigmas); playing messages (the central device will indicate to the ESD what message it has to play at each moment by means of a numerical identifier, in terms of the route which the player is taking); controlling the turn at the start and messages advising the beginning of the match; control of the conclusion of the match; and finally monitoring the battery.

There is a sound system split into two subsystems: that incorporated in each user console and the background sound. The sound incorporated in the console transmits individualized messages to the user through the earpiece of the headphone. These messages are numbered so that at a given time, depending on the status of the user in the tests, the control device will order a certain message to be played. These messages are what direct the user when different options exist (several enigmas in the same room or several exit doors out of a room), or to facilitate his interaction with the game. The system of background sound is present throughout the course and at certain points sequences triggered by the user will be emitted. A computer is in charge of managing the background sound and the interaction with the user is carried out through the control elements.

At the game entrance or waiting area there will be a group of giant screens where images will be projected in real time from several cameras inside, short pre-recordings in digital format, flash ensembles and scores obtained from the central device. These screens are driven by a computer and a switching matrix.

The dual ring optical fibre network guarantees maintenance and monitoring of the control device. The central device will supervise the correct operation of the electronics and, in the event of one of the elements not working, it will activate the possible redundant element and will transmit an alarm signal.

### DESCRIPTION OF THE DRAWINGS

To complete the description and with the object of assisting in a better understanding of the characteristics of the invention, in accordance with an example of practical embodiment thereof, said description is accompanied with, as an integral part thereof, a set of drawings wherein by way of illustration and not restrictively, the following has been represented:

FIG. 1: shows the distribution of the control network with the servers (6) and the switches (7), the cell control computers (1-5) and their control elements (8), as well as the enigma control computers (1′-51′) together with their control elements (10). A user console (8) is also shown interacting with the control element of a cell, and a relay (11) acting in the opening of a door from the control element of an enigma (10).

FIG. 2: shows the preferred embodiment of the user console with the default display of the points obtained by the user, the lives and the time available.

FIG. 3: shows the preferred embodiment of the user console with the display which appears temporarily when the user brings the console near to the activation device of an enigma. The obtained points, lives and enigmas are shown by means of a graphic associated with each type of enigma (touch, smell, sight and ingenuity).

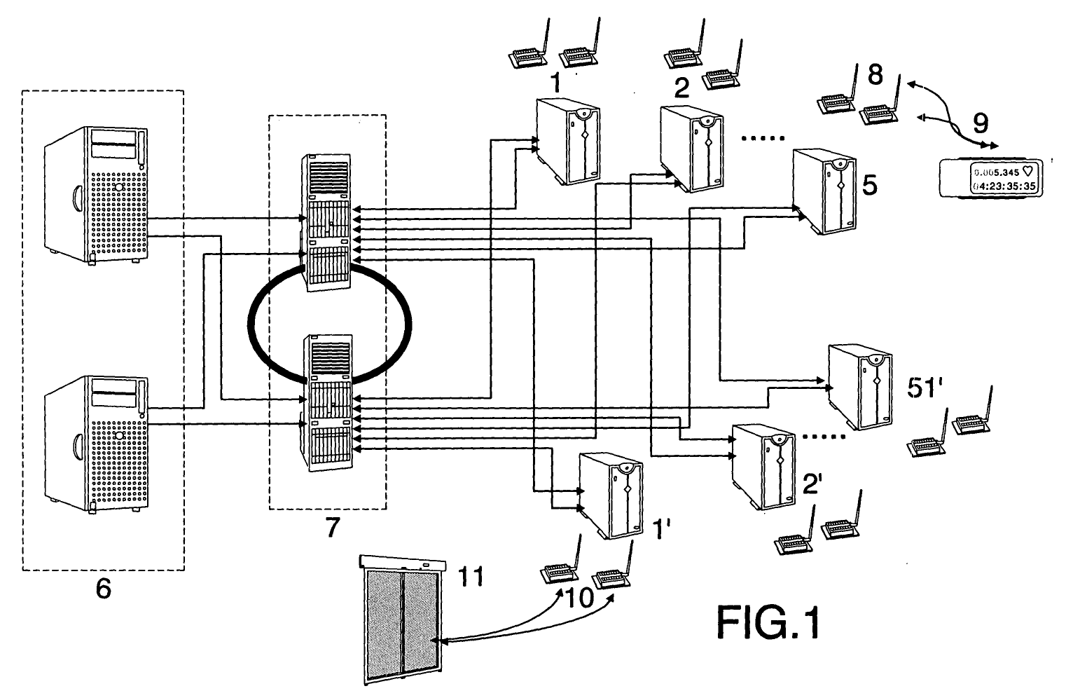

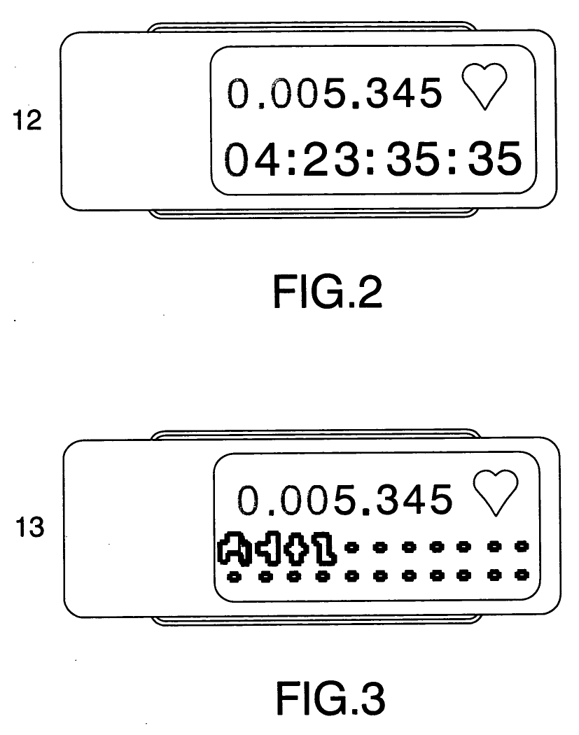

### PREFERRED EMBODIMENT OF THE INVENTION

The preferred embodiment of the control device of the interactive game is conceived for indoor premises.

The device includes several redundant elements to enhance the reliability of the system and of the communications. The dual ring network will be implemented in optical fibre. The servers (6)—the central device—form a cluster. In addition, the information of these servers is periodically replicated in the enigma control computers (1′-51′) and in the cell control computers (1-5), in such to way that if both servers fail, any one of the enigma or cell PCs could take the role of server. In the preferred embodiment of the system the cluster (6) would be formed by two computers. The servers will monitor the correct operation of all the elements of the control device. A distributed control will be implemented. The whole network will be subdivided into individual sub-networks—communication cells—controlled by a PC (1-5).

The number of communication cells in the preferred embodiment will be five, which correspond to the five levels of the game. The cell PCs (1-5) also include a certain redundancy since, by being five they can replace each other. If one fails, control is taken by any one of the other four—that which is designated by programming. If another fails, the following one would replace it, and so on until hypothetically the five fail, at which time the two servers of the cluster (6) could take control of the cells.

The control cell elements (8) are duplicated in each cell computer. If a complete point fails (the two that constitute it), control of that cell is taken by the cell control element indicated by programming. This is achieved by automatically boosting the communication power to have a greater range. If all the cell control points fail (the ten elements), control would be taken by the servers (6), which can also act as cell control elements.

The control elements (10) are almost all duplicated (on doors, in rooms, passing places, enigmas). Their connection to their cell control element (8) is by radio. At each point both are active, and a break in the communication with the cell control element (8), and finally with the server (6), would be controlled by the communication protocol, in order to re-establish communication through the second control element of that point. The embodiments of the control elements can be the following: for control of doors (11), formed by the basic module (comprising a microprocessor, data storage memory, power supply and RF transmitter/receiver with a range of 5 to 10 metres) and an actuation relay; for control of rooms, formed by the basic module and the RF transmitter/receiver; for control of passing places, formed by the basic module and the RF transmitter/receiver; and for control of enigmas, formed by the basic module and a presence detector, to which the user has to bring his console (12) near.

In the enigmas there is a single computer (1′-51′), but with two communication paths, one via cable (two network cards connected to ring 1 and to ring 2), and another by radio. It allows connection by cable to the cell PCs (1-5), and by radio to the control elements and the cell control elements (8). The enigmas are sensory tests which are presented to the user. There are four types of enigma. The sight enigmas comprise some binoculars in the wall from which a screen is observed, where images will be projected about which a question is subsequently formulated to the user. The smell enigmas have a circle with holes through which the fragrance diffuses and a control element of the fragrance machine. The tactile enigmas comprise an access hole to a mitten and a vending type dispenser which rotates in order to put different objects within the reach of the user. These three types of enigma also have a screen to formulate the pertinent question, four mushroom type buttons and an activation point which starts up the enigma when the user brings his console (12) near. The ingenuity enigmas are formed only by the screen, the buttons and the activation point.

The switches (7), which serve as network outlets, are duplicated, and are connected over the ring.

The console or storage device (12) in the particular embodiment of this invention has the form of a wrist watch. Its purpose is to connect the user with the rest of the control device. They are constituted by a case, a microprocessor, a data storage memory, a backlit information display viewer, RTC (real time clock) chronometer, RF (radio-frequency) emitter, RF (radio-frequency) receiver, acoustic warning beeper, RF/ID transponder-identifier, similar to the anti-theft control in shops, MP3 message player, MMC (Multimedia Card), headphone for a single ear and rechargeable batteries. The communication between the console and the rest of the device is carried out through the RF transmitter/receiver or through the RF/ID transponder. The backlit information display viewer has 64×16 pixels in the present preferred embodiment. The points counter will have seven digits. The preferred presentations of the viewer show the chronometer and the score (default presentation of the viewer) (12), or the score, the lives (possibility to obtain an extra life that will give the right to a new session) and the enigmas overcome (visible for a time when the console is recognized by the control element of an enigma when brought near to the sensor) (13).

The cable of the headphone has a distinguishing colour depending on whether the user is a child or an adult, in order to adapt the tests of the game to the type of user by means of different consoles, and therefore different difficulty in the tests of ingenuity.

The system of background sound is present over the whole course of the leisure concept. A computer is in charge of managing the background sound and the interaction with the user.

In some of the enigmas of ingenuity images will be presented in 3D, instead of the images of the computer screen. They will have a holographic appearance, contributing greater realism to the user's sensations when interacting with the tests.

All the information with respect to the control device of the game will be stored in a database. The information which will be stored will be information about the players and the matches. Information will be stored for managing the control device: enigma tests, points to be granted, extra score, extra lives, the messages to the headphone, and the routes inside the game. And finally administration information will be stored like that relative to ticket sales, reservations (via internet), statistics and accounting. The database will be in the central control cluster or central control device.

The central control device (6) is connected to different external elements. It is connected to the mechanical elements like doors (11) or challenges. It is likewise connected to the light and sound system. Another external element connected to the central device is the accounting system, from which the business accounting is managed. It will also be connected with the web through a gateway, where home sales can be facilitated or the possibility of continuing with the game. Finally the central control device is connected with an SMS system through a bidirectional gateway, as another means of continuing the game.

This listing of claims will replace all prior versions, and listings, of claims in the application

1-9. (canceled)

10. An apparatus for controlling an interactive game that manages an interaction between users and game attractions, comprising:
a network of at least one ring;
a server element connected to the network;
a switch element connected to the network;
at least two cell or level control computers connected to the network;
at least two enigma control computers that include sensory tests and tests of ingenuity connected to the network; and
one electronic storage console for each game player configured to communicate, identify and locate the users for the control device of the game to another component.

11. The apparatus according to claim 10, further comprising:
control elements comprising and governed by a microprocessor, the control elements being located in at least one of the cell control computers, the enigma control computers, on doors, in rooms, and passing places of the game area, the control elements being configured to direct actions of the users for the sensory tests and the tests of ingenuity.

12. The apparatus according to claim 11, wherein each control element comprises:
a microprocessor that governs the control element;
a data storage memory configured to store data in the control element;
a connector for network connection configured to connect the control element to the network;
a power supply configured to power the control element; and
a radio-frequency transmitter/receiver configured to provide communications with the control element.

13. The apparatus according to claim 12, wherein each control element further comprises:
at least one of an actuation relay and a radio-frequency reader-identifier that are governed by the control device via the ring network or by radio-frequency.

14. The apparatus according to claim 10, comprising:
a dual ring network;
a cluster of at least two servers connected to the network;
at least two switch elements connected to the network;.
a quantity of cell control computers corresponding to a quantity of levels in the game, the cell control computers being connected to the network with at least two network cards each; and
a quantity of enigma control computers corresponding to a quantity of enigmas in the game, the enigma control computers being connected to the network with at least two network cards each.

15. The apparatus according to claim 10, comprising an electronic storage console for each player, the electronic storage console comprising:
a chronometer (real time clock) providing a time display on the display viewer;
a radio-frequency transmitter for transmitting data to other system components;
a radio-frequency receiver for receiving data from other system components;
an audio output device to provide audio information to the user;
an acoustic warning beeper to alert the user of various situations via the audio output device;
an RF/ID transponder;
a message player configured to output messages to the user via the headphone;
a MMC (multimedia card) configured to process multimedia information; and
a portable power supply.

16. The apparatus according to claim 15, wherein the electronic storage console:
is configured as a bracelet; and
is configured to accumulate a score obtained by the user in the sensory tests (enigmas) and in the tests of skill (challenges).

17. The apparatus according to claim 10, comprising an electronic storage console for each player, wherein, for the electronic storage console:
the audio output device is a headphone;
the message player is an MP3 message player; and
the portable power supply is rechargeable batteries.

18. An apparatus for controlling an interactive game that manages an interaction between users and game attractions, comprising:
a computer network;
a sound system worn by a user of the game;
a control computer connected to the network;
a hologram projector for projecting a 3D image that is connected to the control computer via the network, wherein the hologram projector and the sound system are configured to create an impression that the 3D image is formulating a question to the user (ingenuity enigma in 3D).

19. A method for controlling the apparatus of claim 10, comprising:
providing backup by redundancy to a cluster of servers;
replicating server information by the cluster of servers into at least one of:
a) at least one of the two cell or level control computers, and b) at least one of the two enigma control computers, so that if the servers fail any one of the enigma or cell computers can take the role of the server.

20. A method for controlling the apparatus of claim 10, comprising:
providing backup by redundancy to the cell control computers;
replacing the functions of one cell control computer with another cell control computer in the event of failure; and
replacing the functions of all cell control computers with the server element in the event of a failure of all cell control computers.
